(19) United States
(12) Patent Application Publication
(10) Pub. No.: US 2024/0135665 A1
(43) Pub. Date: Apr. 25, 2024

(54) INFORMATION PROCESSING APPARATUS AND INFORMATION PROCESSING METHOD

(71) Applicant: CANON KABUSHIKI KAISHA, Tokyo (JP)

(72) Inventors: Kouji IKEDA, Tokyo (JP); Yosuke MINE, Tokyo (JP)

(21) Appl. No.: 18/466,865

(22) Filed: Sep. 13, 2023

(30) Foreign Application Priority Data
Oct. 19, 2022 (JP) 2022-168535

(51) Int. Cl. G06T 19/20; G06F 3/01; G06T 7/50; G06T 7/70; H04N 13/398

(52) U.S. Cl. CPC G06T 19/20; G06F 3/014; G06T 7/50; G06T 7/70; H04N 13/398; G06T 2219/2004

(57) ABSTRACT

An information apparatus includes at least one memory and at least one processor which function as: a display control unit configured to perform display control of a virtual object so that the virtual object is disposed in a three-dimensional space which becomes a visual field of a user; and a selection unit configured to set the virtual object included in a selection range in the three-dimensional space, which is selected using an operation body at a position of a hand of the user, to a selected state, wherein the selection range is a three-dimensional range determined by expanding a two-dimensional selected region, which the user specifies using the operation body, in the depth direction.

### BACKGROUND OF THE INVENTION

### Field of the Invention

The present invention relates to an information processing apparatus and an information processing method.

### Description of the Related Art

In recent years, virtual reality (VR) systems, mixed reality (MR) systems, and augmented reality (AR) systems, to integrate a real space and a virtual space, have been developed.

For example, Japanese Patent Application Publication No. 2021-125258 proposes a method for drawing a real object (physical item) selected by a user in an AR scene generated by a computer. Further, Japanese Patent Application Publication No. 2010-17395 proposes a method for selecting an enemy character by circling in a predetermined trace shape using a pen, and registering the selected character as an attack target.

However it is difficult for a user to select a desired virtual object from a plurality of virtual objects (objects) disposed in the depth direction in a three-dimensional virtual space.

### SUMMARY OF THE INVENTION

The present invention provides an information processing apparatus with which the user can easily select a desired virtual object from a plurality of virtual objects disposed in a three-dimensional space.

An information apparatus according to the present invention includes at least one memory and at least one processor which function as: a display control unit configured to perform display control of a virtual object so that the virtual object is disposed in a three-dimensional space which becomes a visual field of a user; and a selection unit configured to set the virtual object included in a selection range in the three-dimensional space, which is selected using an operation body at a position of a hand of the user, to a selected state, wherein the selection range is a three-dimensional range determined by expanding a two-dimensional selected region, which the user specifies using the operation body, in the depth direction.

Further features of the present invention will become apparent from the following description of exemplary embodiments with reference to the attached drawings.

### BRIEF DESCRIPTION OF THE DRAWINGS

FIG. 1 is a block diagram depicting an example of a functional configuration example of an image processing system;

FIG. 2 is a flow chart depicting processing of an information processing apparatus according to Embodiment 1;

FIGS. 3A to 3F are diagrams for describing an example of an operation to change a selected state of a virtual object;

FIG. 4 is a diagram for describing a selection range according to Embodiment 1;

FIG. 5 is a diagram for describing another example of a selection range according to Embodiment 1;

FIG. 6 is a diagram for describing a selection range according to Embodiment 2;

FIG. 7 is a diagram for describing a selection range according to Embodiment 3; and

FIG. 8 is a block diagram depicting an example of a hardware configuration of the information processing apparatus.

### DESCRIPTION OF THE EMBODIMENTS

Embodiments of the present invention will now be described in detail with reference to the drawings. The embodiments to be described below are examples to implement the present invention, and may be changed depending on the configurations and various conditions of the apparatus to which the present invention is applied, hence the present invention is not limited to the following embodiments. It is also possible to combine a part of each embodiment.

### Embodiment 1

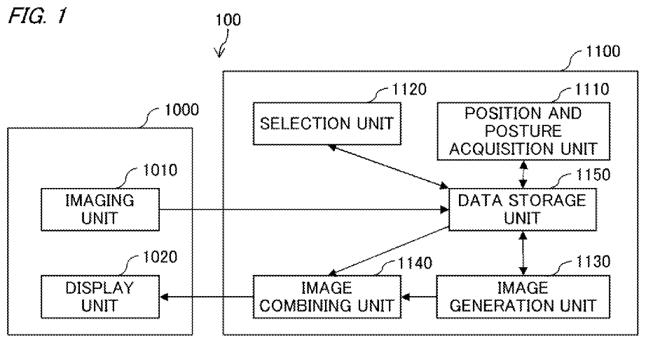

FIG. 1 is a block diagram depicting an example of a functional configuration of an image processing system 100 according to Embodiment 1. The image processing system 100 is, for example, a system to present a mixed reality space (MR space) integrating a real space and a virtual space to a system user (user). The image processing system 100 performs display control so that a virtual object is disposed in a three-dimensional space, which becomes the visual field of the user. The user can select a desired virtual object by specifying (selecting) a selection range in the three-dimensional space.

In the description of Embodiment 1, it is assumed that a composite image generated by combining an image of a real space and an image of a virtual space drawn by computer graphics (CG) is displayed to present an MR space to the user.

The image processing system 100 includes a display device 1000 and an information processing apparatus 1100. The information processing apparatus 1100 can combine an image of a real space loaded from the display device 1000 and an image of a virtual space generated by the information processing apparatus 1100, and outputs the combined image to the display device 1000 as a mixed reality image (MR image).

The image processing system 100 is related to a system that displays an image of a virtual space, and is not limited to a mixed reality (MR) system that displays an MR image generated by combining an image of a real space and an image of a virtual space. The image processing system 100 is also applicable to a virtual reality (VR) system that presents only an image of a virtual space to the user, or an augmented reality (AR) system that presents an image of a virtual space to a user transmitting through a real space.

The display device 1000 includes an imaging unit 1010. The imaging unit 1010 captures images of a real space consecutively in a time series, and outputs the captured images of the real space to the information processing apparatus 1100. The imaging unit 1010 may include a stereo camera which is constituted of two cameras secured to each other so as to image a real space from the line-of-sight position of the user in the line-of-sight direction.

The display device 1000 includes a display unit 1020. The display unit 1020 displays an MR image outputted from the information processing apparatus 1100. The display unit 1020 may include two displays which are disposed corresponding to the left and right eyes of the user respectively. In this case, the display for the left eye corresponding to the left eye of the user displays an MR image for the left eye, and the display for the right eye corresponding to the right eye of the user displays an MR image for the right eye.

The display device 1000 is a head mounted display (HMD), for example. However, the display device 1000 is not limited to an HMD, and may be a hand held display (HHD). The HHD is a display that the user holds with their hand, and the user views an image by looking into the HHD like binoculars. The display device 1000 may also be a display terminal, such as a tablet or a smartphone.

The information processing apparatus 1100 and the display device 1000 are connected such that mutual data communication is possible. The connection between the information processing apparatus 1100 and the display device 1000 may be wireless or via cable. The information processing apparatus 1100 may be disposed inside a casing of the display device 1000.

The information processing apparatus 1100 includes: a position and posture acquisition unit 1110, a selection unit 1120, an image generation unit 1130, an image combining unit 1140 and a data storage unit 1150.

The position and posture acquisition unit 1110 acquires a position and posture of the imaging unit 1010 in a world coordinate system, and a position of a hand of the viewer (user). Specifically, the position and posture acquisition unit 1110 extracts markers assigned in the world coordinate system based on an image of the real space captured by the imaging unit 1010. The position and posture acquisition unit 1110 acquires the position and posture of the imaging unit 1010 in the world coordinate system based on the position and posture of the markers, and outputs the acquired position-and-posture information of the imaging unit 1010 to the data storage unit 1150.

The position and posture acquisition unit 1110 extracts a feature region of a hand from the image of the real space captured by the imaging unit 1010. The position and posture acquisition unit 1110 acquires the position information of each area of the hand, using the extracted feature region of the hand and the shape information of the hand stored in the data storage unit 1150. The position information of each area of the hand may be position information of a part of the hand, such as a fingertip or a joint of each finger. The position and posture acquisition unit 1110 is required only to acquire position information of an area which the selection unit 1120 uses for setting the selection range, and in a case where the user specifies the selection range using a fingertip, for example, the selection unit 1120 can acquire the position information of the fingertip.

The method for acquiring the position and posture of the imaging unit 1010 is not limited to the above method. For example, the position and posture acquisition unit 1110 may execute processing of the simultaneous localization and mapping (SLAM) based on the feature points captured in the image, whereby the position and posture of the imaging unit 1010 and the position and posture in the individual coordinate system may be determined.

The position and posture of the imaging unit 1010 may also be determined by installing a sensor, of which relative position and posture with respect to the imaging unit 1010 is known, on the display device 1000, and using a measured value by this sensor. The position and posture acquisition unit 1110 can determine the position and posture of the imaging unit 1010 in the world coordinate system by converting the measured value by the sensor based on the relative position and posture with respect to the imaging unit 1010 of the sensor. The position and posture acquisition unit 1110 may also determine the position and posture of the imaging unit 1010 using a motion capture system.

The method for acquiring the position of the hand of the user is not limited to the above method. For example, if the imaging unit 1010 is a single lens camera, the position and posture acquisition unit 1110 can acquire the position of the hand using a time of flight (ToF) sensor. Further, if the imaging unit 1010 has a plurality of cameras of which positions and postures are different, the position and posture acquisition unit 1110 may acquire the position of the hand based on the images captured by the plurality of cameras. For example, the position and posture acquisition unit 1110 can acquire the position of the hand by determining the depth of the entire image based on a stereoscopic image using such a method as semi global matching (SGM), and using the depth information and the shape information of the hand.

The position and posture acquisition unit 1110 may acquire the position of the hand by the user wearing a glove, which includes sensors to acquire the position of each joint of the hand. The position and posture acquisition unit 1110 may also acquire the position of the hand using a motion capture system. In the case where the user operates an MR controller at the position of their hand, the position and posture acquisition unit 1110 may acquire the position of the controller as the position of the hand.

The selection unit 1120 sets a selection range in a virtual space based on the position of the hand of the user acquired by the position and posture acquisition unit 1110. The selection unit 1120 also changes the selection state of the data (virtual object) in the virtual space included in the selection range.

The image generation unit 1130 constructs a virtual space based on the data on the virtual space stored in the data storage unit 1150. The data on the virtual space includes data on each virtual object constituting the virtual space, data on an approximate reality object generated by loading the three-dimensional shape information on the real object acquired from the real space into a virtual space, and data on a light source that illuminates the virtual space.

The image generation unit 1130 sets a virtual viewpoint based on the position and posture of the imaging unit 1010 acquired by the position and posture acquisition unit 1110. For example, the image generation unit 1130 can set a position of a dominant eye of the user, or a mid-point between the left and the right eyes of the user, as the virtual viewpoint. The dominant eye of the user can be set in advance. In the case where the imaging unit 1010 includes a plurality of cameras, the image generation unit 1130 can set the virtual viewpoint based on the positional relationship between the position of each camera and the positions of the eyes of the user when the user is wearing the HMD (display device 1000).

The image generation unit 1130 generates an image of a virtual space (virtual space image) viewed from the viewpoint that was set. The technique to generate an image of a virtual space viewed from a viewpoint, based on a predetermined position and posture, is known, hence detailed description thereof will be omitted.

The image combining unit 1140 combines the image of the virtual space generated by the image generation unit 1130 and the image of the real space captured by the imaging unit 1010, and generates an MR image (image of three-dimensional space) thereby. The image combining unit 1140 outputs the generated MR image to the display unit 1020.

The data storage unit 1150 includes a RAM, a hard disk drive, and the like, and stores various information mentioned above. The data storage unit 1150 also stores information to be described as “known information” and various setting information.

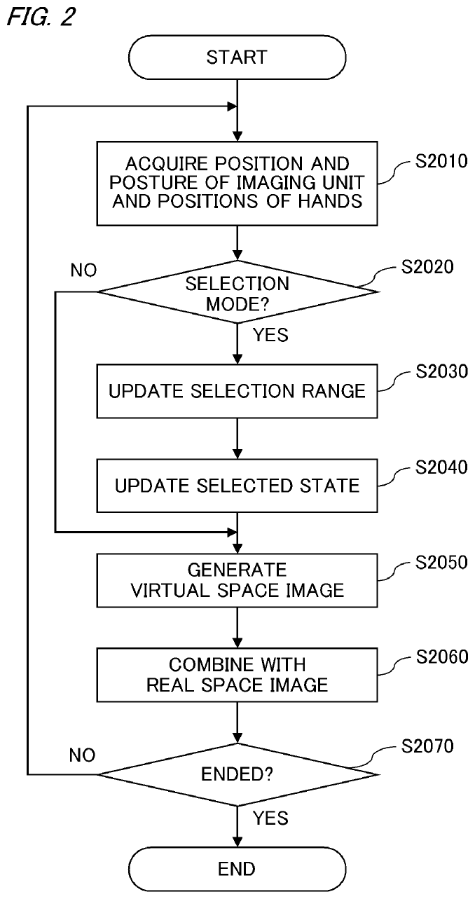

FIG. 2 is a flow chart depicting an example of processing when the information processing apparatus 1100 generates an MR image and outputs the MR image to the display device 1000.

In step S2010, the position and posture acquisition unit 1110 acquires the position and posture of the imaging unit 1010 and the position of the hand of the user. The position of the hand of the user includes such information as a position of each area (e.g. fingertip, joint) of the hand, and a position of a controller worn or held by the hand. From this information, the position and posture acquisition unit 1110 can acquire information used for setting of the selection range.

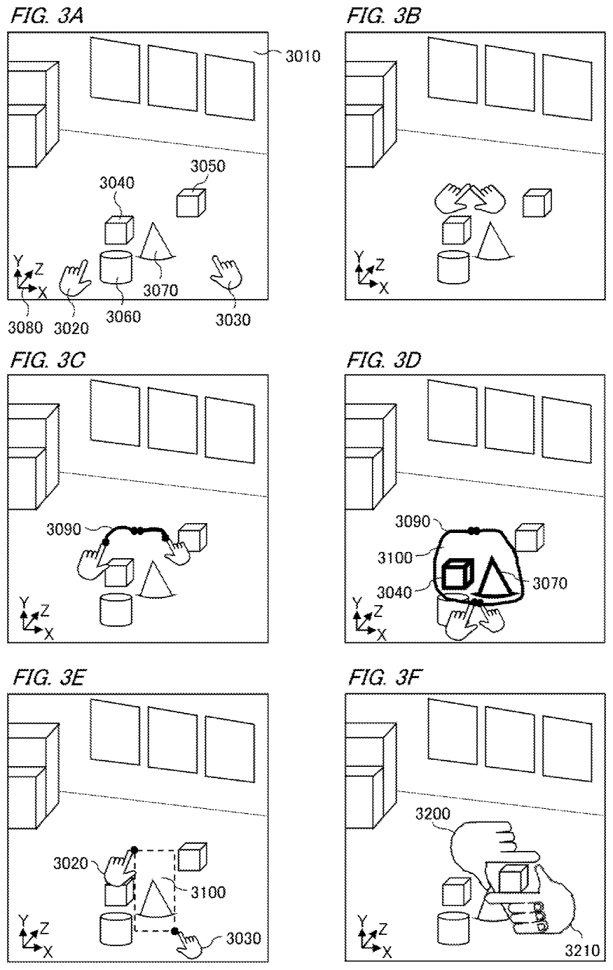

In step S2020, the selection unit 1120 determines whether or not the current mode is a mode to select a virtual object (selection mode). The method for determining whether or not the mode switched to the selection mode will be described later with reference to FIGS. 3A to 3F. Processing advances to step S2030 if it is determined that the current mode is the selection mode. Processing advances to step S2050 if it is determined that the current mode is not the selection mode.

In step S2030, based on the position of the hand of the user, the selection unit 1120 updates the selection range to change the selection state of a virtual object which is disposed and displayed in the virtual space. The selection range is a three-dimensional range determined by expanding a two-dimensional selection region, which is specified using an operation body at the position of the hand of the user, in the depth direction. The operation body may be the hand of the user, or a controller. In the following description, it is assumed that the operation body is the hand of the user.

In step S2040, based on the updated selection range, the selection unit 1120 updates the selection state of a virtual object included in this selection range. The selection unit 1120 sets a virtual object included in the selection range to a selected state, and sets a virtual object not included in the selection range to a deselected state. The virtual object included in the selection range may be a virtual object which is entirely included in the selection range, or may be a virtual object of which part (at least a predetermined ratio) is included in the selection range. Further, the virtual object included in the selection range may be a virtual object of which center of gravity is included in the selection range.

In step S2050, the image generation unit 1130 generates an image of the virtual space viewed from the virtual viewpoint, using the information on the position and posture of the imaging unit 1010 acquired in step S2010.

In step S2060, the image combining unit 1140 generates an MR image by combining the image of the virtual space generated in step S2050 and an image of the real space (real space image) captured by the imaging unit 1010.

In step S2070, the information processing apparatus 1100 determines whether or not an end condition is satisfied. For example, the information processing apparatus 1100 can determine that the end condition is satisfied when an end instruction, to end the processing to generate the MR image, is inputted. The information processing apparatus 1100 ends the processing in FIG. 2 if the end condition is satisfied. The information processing apparatus 1100 returns to the processing in step S2010 if the end condition is not satisfied.

FIGS. 3A to 3F are diagrams for describing an example of an operation to change the selection state of a virtual object. FIGS. 3A to 3F indicate an example of a composite image generated by the image combining unit 1140. FIGS. 3A to 3F also indicate an example of changing the selection state of a virtual object by setting a selection range in the virtual space using the selection unit 1120.

The real space image 3010 is an image of a real space, and is an image captured by the imaging unit 1010. The real space image 3010 is combined with an image of a virtual space where various objects are disposed.

In the composite image generated by combining the real space image 3010 and the image of the virtual space, objects indicating a left hand 3020 and a right hand 3030 of the user are disposed. In the composite image, objects indicating virtual objects 3040, 3050, 3060 and 3070 are also disposed. Coordinate axes 3080 indicate a coordinate system in the virtual space. The X axis direction corresponds to the lateral direction of an MR image displayed on the display. The Y axis direction corresponds to the longitudinal direction of the MR image displayed on the display. And the Z axis direction corresponds to the depth direction of the virtual space.

Traces 3090 of the hands to set a selection range may also be displayed in the composite image. Further, a selected region 3100 may be displayed in the composite image. The selected region 3100 is a two-dimensional region enclosed by the positions of the hands of the user, or the traces 3090 of the fingertip positions. The three-dimensional selection range in the virtual space is set by expanding the selected region 3100 in the depth direction.

FIG. 3A indicates a state where the selected state of the virtual objects in the virtual space is not changed. The image generation unit 1130 generates a virtual space image based on the position and posture of the imaging unit 1010 acquired by the position and posture acquisition unit 1110. The image combining unit 1140 generates the MR image (composite image) by combining the virtual space image and the real space image captured by the imaging unit 1010.

FIG. 3B indicates a state where the selection mode, to change the selected state of the virtual objects, is started. In the example in FIG. 3B, the selection mode starts when the distance between the left hand 3020 and the right hand 3030 of the user becomes a threshold or less.

The position and posture acquisition unit 1110 acquires the positions of the left hand 3020 and the right hand 3030 of the user. In the example of FIG. 3B, the position and posture acquisition unit 1110 can acquire the position of the fingertip of the index finger as the position of the hand. The selection unit 1120 sets the selected region 3100 based on the positions of the left hand 3020 and the right hand 3030 of the user. Based on the selected region 3100, the selection unit 1120 sets the selection range in the virtual space, and changes the selected state of the virtual objects included in the selection range.

The condition to start the selection mode may be that the distance between the left hand and the right hand is a predetermined time threshold or less. The selection mode may be started by the user operation performed via an input device (e.g. button). The selection mode may also be started by an instruction performed by the user via their line-of-sight or voice.

In FIG. 3C, the traces 3090 of the hands are displayed in the case where the left hand 3020 and the right hand 3030 of the user moved away from each other in the state in FIG. 3B.

FIG. 3D indicates a state where the left hand 3020 and the right hand 3030 of the user in the state in FIG. 3C further move such that the virtual objects are enclosed, and the distance of the hands becomes the threshold or less again. The position and posture acquisition unit 1110 acquires the positions of the left hand 3020 and the right hand 3030 of the user, and the selection unit 1120 sets the selected region 3100 based on the acquired information on the positions of the hands. The selection unit 1120 sets the selected region 3100 and ends the selection mode.

The condition to end the selection mode may be that the distance between the left hand and the right hand becomes the threshold or less. The selection mode may also be ended when the shapes of the hands are changed (e.g. bending finger tips). Further, the selection mode may be ended by the user operation performed via an input device (e.g. button), or may be ended by an instruction performed by the user via their line-of-sight or voice.

In FIG. 3D, a virtual object 3040 and a virtual object 3070 are included in the selection range determined by expanding the selected region 3100 in the depth direction, and the selection unit 1120 changes the states of the virtual object 3040 and the virtual object 3070 to the selected state. The virtual object 3040 and the virtual object 3070 in the selected state may be displayed with emphasis, such as using a thicker contour than the other virtual objects, or by a highlight display. All that is required to display a virtual object in the selected state is that the display mode is different from the unselected state (deselected state), and this display mode may be a wire frame display, or a display with a different color or different transparency from the deselected state.

Determining whether or not a virtual object is included in the selection range is not limited to determining whether or not the entire virtual object is in the selection range. Determining whether or not a virtual object is included in the selection range may be determining whether or not a center of gravity of the virtual object is in the selection range, determining whether or not the entire virtual object (each vertex of a rectangular parallelepiped circumscribing the virtual object) is in the selection range, or determining whether or not at least a predetermined ratio of the virtual object is in the selection range.

FIGS. 3A to 3D are examples when the user specifies the selected region 3100 using both of their hands, but the selected region 3100 may be specified using one hand. For example, the user determines the start point and end point of the selected region 3100 by changing the shape of one hand to a predetermined shape, so that the region enclosed by the trace 3090 of the hand from the start point to the end point is specified as the selected region 3100.

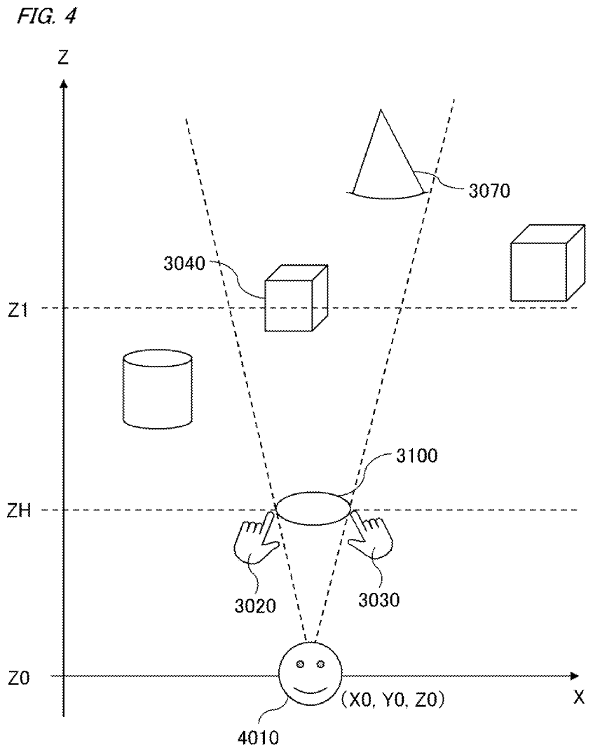

FIG. 4 is a diagram for describing a selection range according to Embodiment 1. Specifically, a method for determining the coordinates of a selection range that is set in the virtual space will be described. The selection range is a three-dimensional range generated by expanding the two-dimensional selected region 3100 in the depth direction, as described in FIG. 3D. In FIG. 4, the coordinates of the selection range are described on a two-dimensional plane, constituted of the Z axis (depth direction) and the X axis (lateral direction), out of the three-dimensional space constituted of the X, Y and Z axes.

An origin 4010 in the viewing direction corresponds to the position of the user, and specifically is a position where the user is viewing the virtual space. The origin 4010 can be a position of the left or right eye of the user, or a position of a dominant eye of the user. If the position of the camera mounted on the display device 1000 is approximately the same as the position of the eye of the user, the origin 4010 can be the position of the camera.

In the case where the position of the camera and the position of the eye of the user are different, such as where the imaging unit 1010 of the display device 1000 includes a plurality of cameras, the origin 4010 can be the position of the viewpoint of the user (virtual viewpoint) converted from the position of the camera. The position of the virtual viewpoint may be a position of the dominant eye or may be a mid-point between the left and right eyes.

Here it is assumed that the coordinates of the origin 4010 are (X0, Y0, Z0). The Z coordinate of the left hand 3020 and the right hand 3030 in the depth direction is ZH. In other words, the Z direction coordinate of the two-dimensional selected region 3100 enclosed by the traces of the hands of the user is ZH.

The selected region 3100 may be a region enclosed by the traces 3090 of the hands of the user approximated to a rectangle, an ellipse, or the like. If the selected region 3100 is determined by approximating the traces 3090 that the user actually specified into such a shape as a rectangle or ellipse like this, the computing amount to determine the coordinates of the three-dimensional selection range can be reduced.

In the following description, the selected region 3100 is assumed to be a rectangle. For example, the coordinates of one vertex can be defined as (XHS, YHS, ZH), and the coordinates of the vertex at the opposite angle can be defined as (XHE, YHE, ZH). In other words, the selected region 3100 is a region enclosed by the four points of (XHS, YHS, ZH), (XHS, YHE, ZH), (XHE, YHE, ZH) and (XHE, YHS, ZH).

The selection unit 1120 expands the selected region 3100 in the Z axis direction (depth direction). In a case where a rectangular parallelepiped is formed as a selection range by changing only the Z axis coordinate of the selected region 3100, the range of the formed rectangular parallelepiped may deviate from the range of the selected region 3100 the user is viewing. Therefore the selection unit 1120 expands the selected region 3100 in the depth direction based on the position of the user and the position on the contour of the selected region 3100, so that a visual deviation is not generated.

The following calculation example indicates the method for determining the selection range in a case where the coordinates of a center of gravity of a virtual object 3040 in the Z axis direction is Z1. The distance in the Z direction from the position of the user to the hand is (ZH-Z0). The distance in the Z direction from the position of the user to the center of gravity of the virtual object 3040 is (Z1-Z0)/(ZH-Z0) times of the distance from the position of the user to the hand. Here it is assumed that (Z1-Z0)/(ZH-Z0)=k.

A vertex at the Z coordinate Z1, corresponding to one vertex (XHS, YHS, ZH) of the two-dimensional selected region 3100 is (k×(XHS−X0)+X0, k×(YHS−Y0)+Y0, Z1). In the same manner, a vertex at the Z coordinate Z1, corresponding to another vertex (XHE, YHE, ZH) is (k×(XHE−X0)+X0, k×(YHE−Y0)+Y0, Z1). By adjusting the X coordinate and the Y coordinate like this in accordance with the position of the virtual object in the depth direction, the selection unit 1120 can appropriately set the three-dimensional selection range according to the intension of the user.

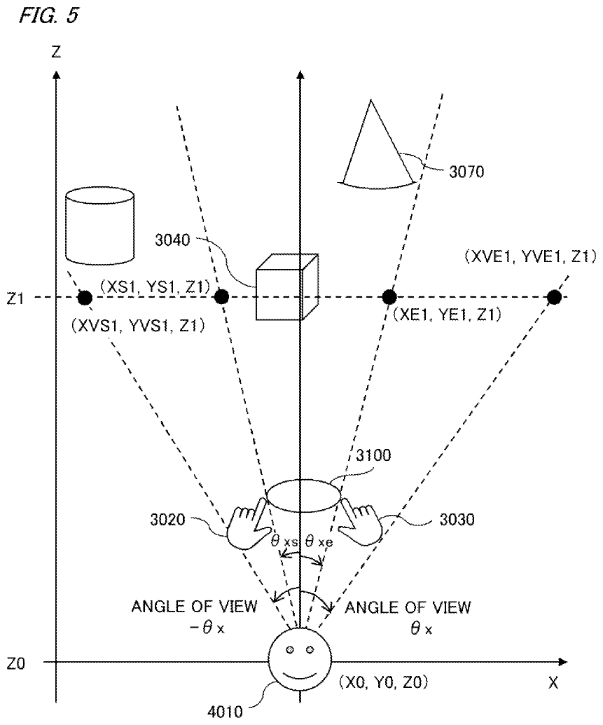

FIG. 5 is a diagram for describing another example of a selection range according to Embodiment 1. In FIG. 4, the coordinate of the selection range at the Z coordinate Z1 is determined using the coordinates of the position on the contour of the selected region 3100 (position of a vertex if the selected region 3100 is a rectangle), but an angle of view of the two-dimensional selected region 3100 may be used without using ZH. In other words, the selection unit 1120 sets the selection range by using: the origin 4010 corresponding to the position of the user; and the range from the origin 4010 in the directions toward which the hands (operation bodies) face. The method for using the range in the directions toward the hands are directed is effective when measuring the distances to the hands is difficult.

The method for determining the selection range using the angle of view of the selected region 3100 will be described with reference to FIG. 5. In FIG. 5, the selection range on the XZ plane constituted of the X axis and the Z axis is indicated, but the selection range on the YZ plane can also be indicated in the same manner, if the X axis is regarded as the Y axis, and the angle θx is regarded as θy.

The angle of view of a space which the user is viewing is determined by the angle of view (θx, θy) of the camera mounted on the HMD, with respect to the direction the user is viewing. It is assumed that an angle formed by: a line which passes through one vertex of the selected region 3100 approximating a rectangle and the origin 4010 within the angle of view of the camera; and a line, which passes through the origin 4010 and is parallel with the Z axis is (θxs, θys). And it is assumed that a line which passes through another vertex on the opposite side and the origin 4010; and a line which passes through the origin 4010 and is parallel with the Z axis is (θxe, θye).

For example, the coordinates of the edges of the angle of view of the camera (XVS1, YVS1, Z1) and (XVE1, YVE1, Z1) at the distance of the Z coordinate Z1 are determined by the following expressions using the angle of view of the camera.

XVS1=X0+(Z1−Z0)×tan−θx

YVS1=Y0+(Z1−Z0)×tan−θy

XVE1=X0+(Z1−Z0)×tan θx

YVE1=Y0+(Z1−Z0)×tan θx

Using the same calculation method, the coordinates of one vertex (XS1, YS1, Z1) in the selection range at the distance of the Z coordinate Z1 are determined by the following expressions.

XS1=XVS1+(Z1−Z0)×(tan θx−tan θxs)

YS1=YVS1+(Z1−Z0)×(tan θy−tan θys)

In the same manner, the coordinates of the other vertex (XE1, YE1, Z1) are determined by the following expressions.

XE1=XVE1−(Z1−Z0)×(tan θx−tan θxe)

YE1=YVE1−(Z1−Z0)×(tan θy−tan θye)

In the case where the selected region 3100 is not a rectangle, the selection unit 1120 may approximate the selected region 3100 to a rectangle, whereby calculation amount can be reduced.

In Embodiment 1 described above, the information processing apparatus 1100 sets the selection range by expanding the selected region 3100, which is specified using such an operation body as the hands of the user or a controller, in the depth direction. Specifically, the information processing apparatus 1100 can set the selection range by expanding the selected region 3100 in the depth direction, using the origin which corresponds to the position of the user, and a position on the contour of the selected region 3100.

Further, the information processing apparatus 1100 may select the selection range using the origin, which corresponds to the position of the user, and a range from the origin in a direction toward which the operation body faces. Specifically, the information processing apparatus 1100 may set a selection range using an angle formed by: a line which passes through the origin 4010 and a point on the contour of the selected region 3100; and the Z axis. The contour of the selected region 3100 may be approximated to a rectangle or the like to reduce the calculation amount.

For the selection range, the range on the XY plane is determined based on the distance Z1 from the origin in the depth direction. Therefore the selection unit 1120 can approximately determine whether or not a virtual object is included in the selection range in accordance with the position of the virtual object in the depth direction. Hence the user can smoothly select a plurality of virtual objects disposed in the three-dimensional space as intended, without generating a visual deviation.

### Modification 1

Modification 1 of Embodiment 1 will be described with reference to FIG. 3E. In Embodiment 1, the selected region 3100 is set based on the traces 3090 of the hands. In Modification 1, on the other hand, the selected region 3100 is specified based on position information on a plurality of points specified by the hands of the user.

For example, the user can specify the selected region 3100 by instructing the positions of two points using the left hand 3020 and the right hand 3030. Specifically, as illustrated in FIG. 3B, the information processing apparatus 1100 starts the selection mode to select virtual objects when the distance between the left hand 3020 and the right hand 3030 of the user becomes a threshold or less.

As the first vertex of the selected region 3100, the selection unit 1120 specifies the position of the fingertip of the index finger of the left hand 3020 when the selection mode is started. Then the user moves the right hand 3030, as illustrated in FIG. 3E, so as to specify the second vertex of the selected region 3100. As the second vertex of the selected region 3100, the selection unit 1120 specifies the position of the fingertip of the index finger of the right hand 3030 when the movement of the right hand 3030 stopped. Then as the selected region 3100, the selection unit 1120 can set a rectangle where the first vertex indicated by the left hand 3020 and the second vertex indicated by the right hand 3030 are vertexes on a diagonal line.

The user may specify the selected region 3100 by specifying three or more points, instead of two points. For example, the selected region 3100 may be a region of a circle passing through three points specified by the user, or a rectangle passing through four points specified by the user. The user can easily specify the selected region 3100 by specifying positions of a plurality of points.

### Modification 2

Modification 2 of Embodiment 1 will be described with reference to FIG. 3F. In Embodiment 1, the selected region 3100 is specified based on the traces 3090 of the hands. In Modification 2, on the other hand, the selected region 3100 is specified by a region enclosed by a predetermined shape of the hands of the user. The predetermined shape of the hands of the user is a shape formed by two fingertips of one hand approaching two fingertips of the other hand respectively, or is a shape formed by approaching two fingertips of one hand toward each other, for example.

In FIG. 3F, for example, the user forms a frame shape by making an L shape with the thumb and index finger of the left hand 3200 and the right hand 3210 respectively, and approaching the thumb of the left hand 3200 toward the index finger of the right hand 3210, and approaching the index finger of the left hand 3200 toward the thumb of the right hand 3210. The selection unit 1120 can set the formed frame shape as the selected region 3100.

The predetermined shape of the hands may be a shaped formed by one hand. For example, the user forms a circle by touching the tips of the thumb and the index finger of one hand. Thereby the selection unit 1120 can set the region of the formed circle as the selected region 3100. By forming a predetermined shape with hands, the user can easily specify the selected region 3100.

### Embodiment 2

Embodiment 1 is an embodiment where the selection range in the three-dimensional shape is set based on the selected region 3100 specified by an operation body, such as the hand of the user. Embodiment 2, on the other hand, is an embodiment where a selection range in the three-dimensional space is set based on a trace of a laser beam-like object (hereafter called “ray”) emitted from a position of the hand of the user. The ray may be displayed as if being emitted from the hand by hand tracking, or may be displayed as if being emitted from a controller held by the hand of the user.

In Embodiment 2, the selection unit 1120 determines a range on a two-dimensional plane in accordance with the depth distance from an emission position of the ray to the virtual object, based on an emission angle of the ray with respect to the depth direction, and determines whether the virtual object is included in the selection range.

The configuration of the image processing system 100 according to Embodiment 2 is the same as Embodiment 1. In the following, aspects different from Embodiment 1 will be mainly described. In Embodiment 1, the selection unit 1120 sets a selection range based on the selected region 3100 specified by the hands of the user, the controller, or the like. In Embodiment 2, on the other hand, the selection unit 1120 sets the selection range based on the direction specified by the ray emitted from the hand of the user, an XR controller held by the user, or the like.

The user can specify the selection range at a distant position by changing the direction of the ray. For example, the selection unit 1120 can set the selection range by expanding the conical shape, enclosed by the trace of the ray, in the depth direction. The ray may be displayed by a point (pointer) at which the ray crosses with a virtual object or the like that exists in the direction of the ray, instead of being displayed as a laser beam. In this case, the selection unit 1120 can set the selection range by expanding the conical shape, which is enclosed by a line connecting the origin position, at which the ray is emitted, and the pointer, in the depth direction. In the following description, the ray is an object displayed in a laser beam-like form, but the present embodiment is also applicable to the case where the ray is displayed as a pointer.

The selection unit 1120 can determine a region on the XY plane (region where the selection range intersects with the XY plane) at the distance Z1, in the depth direction (Z axis direction) from the position of the user, based on the angle of the ray with respect to the depth direction.

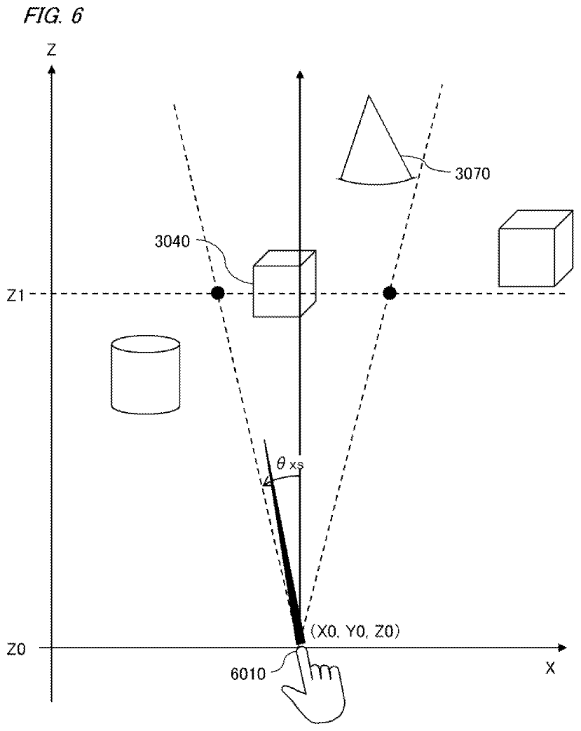

FIG. 6 is a diagram for describing the selection range according to Embodiment 2. An origin 6010 is a position from which the ray is emitted, and corresponds to the position of a hand or a fingertip of the user, or a ray emission position of the XR controller held by the user. Unlike Embodiment 1, the origin 6010 is not a position of a viewpoint of the user viewing the three-dimensional space, but is a position where the ray is emitted. Here the coordinates of the origin 6010 are assumed to be (X0, Y0, Z0).

In the case where the user specifies the selection range using the ray, the condition to start the selection mode may be that the user changed the shape of the hand to a predetermined shape, for example. The selection mode may also be started by a user operation via an input device (e.g. button). Furthermore, the selection mode may be started by an instruction from the user via their line-of-sight or voice. The selection unit 1120 sets the selection range based on the range enclosed by the trace of the ray from the start to the end of the selection mode.

The condition to end the selection mode may be that the user changed the shape of their hand to a predetermined shape, just like the case of starting the selection mode. The predetermined shape used to start the selection mode and to end the selection mode may be the same, or may be different. The selection mode may also be ended by user operation via an input device, or by an instruction from the user via their line-of-sight or voice.

In the selection mode, the length of the ray may be a distance to a virtual object closest to the user, or may be a distance to a virtual object most distant from the user. The length of the ray may also be an average value of the distances to a plurality of virtual objects existing in the virtual space, or may be a distance to an object which the ray contacts first after the selection mode started. During the selection mode, the length of the ray may be constant. If the length of the ray is constant, the user can more easily select a desired range.

When the angle of the selection range is specified by the trace of the ray, the selection unit 1120 sets the selection range based on the specified angle. If the emission angle of the ray, with respect to the front face direction (Z axis direction) is (θxs, θys), then the coordinates of the selection range at the distance of Z1 is given by (X0+(Z1−Z0)×tan θxs, Y0+(Z1−Z0)×tan θys, Z1).

The selection unit 1120 can determine a region on the XY plane at the Z coordinate Z1 of the selection range, by repeating the calculation of the coordinates using the angle formed by the ray, which the user moves, and the Z axis direction. In this way, the selection unit 1120 can determine a region intersecting with the XY plane, according to the distance Z1 in the depth direction.

In the case where the user selected a conical range using the ray, the selection unit 1120 may set the selection range by approximating the conical range selected by the user to a circumscribing quadrangular pyramid. If the range selected by the user is approximated to a quadrangular pyramid, the selection unit 1120 can reduce the calculation amount to calculate the coordinates.

In Embodiment 2, the information processing apparatus 1100 sets the selection range based on the trace of the ray. Specifically, the information processing apparatus 1100 sets the selection range using the angle of the ray specified by the user, with respect to the depth direction.

For the selection range, the range on the XY plane is determined based on the distance Z1 from the origin in the depth direction. Therefore the selection unit 1120 can appropriately determine whether or not a virtual object is included in the selection range in accordance with the position of the virtual object in the depth direction. Hence the user can smoothly select a plurality of virtual objects disposed in the three-dimensional space as intended, without generating a visual deviation. Furthermore, by specifying the selection range using the ray, the user can select a virtual object more accurately.

### Embodiment 3

Embodiment 1 is an embodiment where the selection range is set specifying the virtual viewpoint as the origin (origin 4010 in FIGS. 4 and 5), regardless the number of cameras included in the imaging unit 1010. Embodiment 3, on the other hand, is an embodiment where the imaging unit 1010 is a stereo camera including two cameras which are secured to each other, corresponding to the left and right eyes, so that the real space in the line-of-sight direction can be imaged from the viewpoint position of the user.

In Embodiment 3, the selection unit 1120 sets the selection range specifying the position of the dominant eye of the user as the origin. If the imaging unit 1010 includes a camera that is disposed approximately at the same position as the position of the dominant eye of the user, the selection unit 1120 can set the position of this camera as the position of the origin.

The configuration of the image processing system 100 according to Embodiment 3 is the same as Embodiment 1. In the following, aspects different from Embodiment 1 will be mainly described. Embodiment 3 is an embodiment where the selection range is set specifying the position of the dominant eye as the origin, and the image processing system 100 includes a configuration to set which of the left and right eyes of the user is the dominant eye. The display device 1000 or the information processing apparatus 1100 may display a menu screen for the user to set which eye is the dominant eye, and receive the operation to set the dominant eye of the user. In a case where the information on the dominant eye is not available, the display device 1000 may automatically determine and set the dominant eye of the user based on a known technique. The dominant eye of the user may be an eye that is set in advance.

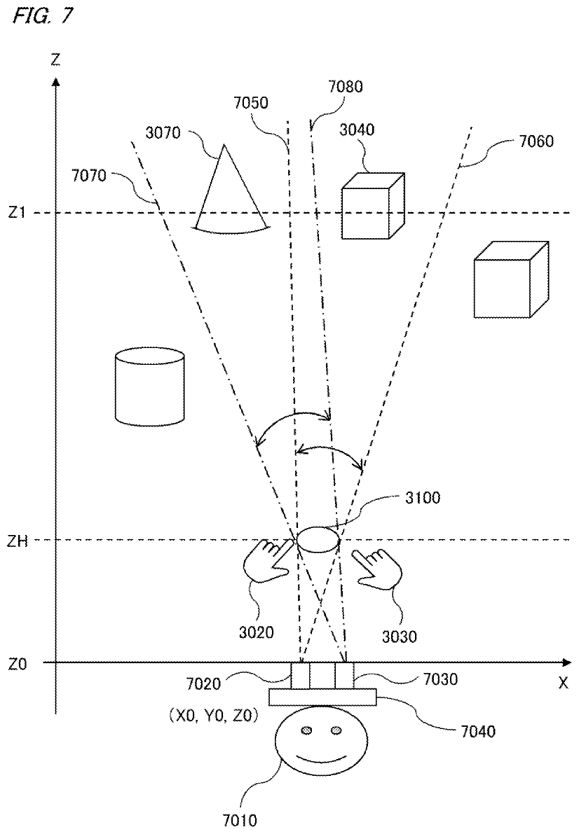

FIG. 7 is a diagram for describing the selection range according to Embodiment 3. An effect of specifying the position of the dominant eye as the origin will also be described with reference to FIG. 7. In Embodiment 3, it is assumed that the camera, corresponding to the dominant eye, is disposed at the position of the dominant eye.

An HMD 7040, worn by a user 7010 experiencing the MR space, includes two cameras (a camera 7020 and a camera 7030). The camera 7020 and the camera 7030 are assumed to be cameras disposed at approximately the same positions as the left eye and the right eye of the user respectively. The dominant eye of the user here is assumed to be the left eye, and the camera on the dominant eye side is the camera 7020. The origin in the viewing direction is the position at the center of the camera 7020 on the dominant eye side. The coordinates of the origin are assumed to be (X0, Y0, Z0).

The user specifies the selected region 3100 in the same manner as Embodiment 1. Just like the case described in FIG. 4, the selection unit 1120 can set the selection range by expanding the selected region 3100 in the depth direction using the origin and a position on the contour of the selected region 3100. Further, just like the case described in FIG. 5, the selection unit 1120 may set the selection range using the angle of view θ of the camera on the dominant eye side, and the angle formed by: the line connecting the position on the contour of the selected region 3100 and the origin; and the depth direction.

As the selection range in the three-dimensional space, the selection unit 1120 sets a space enclosed by a plurality of lines (e.g. dotted line 7050 and dotted line 7060 in FIG. 7), which extend from the origin (X0, Y0, Z0) in the direction of the field-of-view of the left eye, passing through the points on the contour of the selected region 3100. In the distance Z1 from the origin, the virtual object 3040 included in the selection range becomes the selected state.

If the position of the camera 7030, which is not on the dominant eye side, is specified as the origin, on the other hand, a space enclosed by a plurality of lines (e.g. dash line 7070 and dash line 7080 in FIG. 7), which extend from the origin in the direction of the field-of-view of the right eye, passing through the points on the contour of the selected region 3100, is set as the selection range in the three-dimensional space. In this case, even if the user, whose dominant eye is the left eye, attempts to select the virtual object 3040 at the distance Z1, the virtual object 3070 is selected and the intended range is not selected. Therefore in the case of using a stereo camera (dual lens camera) as the imaging unit 1010, it is critical to specify the position of the camera on the dominant eye side as the origin.

In the case where the information on the dominant eye is not set, the origin (X0, Y0, Z0) in the viewing direction may be set to a mid-point at the center positions between the two cameras, instead of the center position of either the left or right camera. By setting the mid-point between the cameras, errors generated by the parallax of the left and right eyes can be reduced by almost half.

When the selection mode starts, the display unit 1020 of the HMD (display device 1000) may display an image captured by either one of the left and right camera, on the left and right displays respectively. For example, when the selection mode starts, the display unit 1020 switches an image to be displayed on the display for the right eye to an image captured by the camera for the left eye. Then the selection unit 1120 specifies the position of the camera corresponding to the currently display image as the origin (X0, Y0, Z0) in the viewing direction.

When the selection mode ends, the display unit 1020 returns the images displayed on the left and right displays of the HMD back to the images captured by the corresponding cameras respectively. For example, in the case where the selection mode started and the image displayed on the display for the right eye was switched to the image captured by the camera for the left eye, the display unit 1020 returns the image displayed on the right eye side back to the image captured by the camera for the right eye.

When the selection mode starts, an image captured by either the left or the right cameras is displayed on the left and right displays, hence it can be avoided that an intended range is not selected due to the deviation between the image for the left eye and the image for the right eye. Therefore the selection unit 1120 can set a selection range as the user intended.

In Embodiment 3 described above, if the imaging unit 1010 is a dual lens camera, the selection range is set specifying the position of the camera on the dominant eye side (position of the dominant eye) as the origin, hence an error of the selection range can be reduced. Therefore the user can smoothly select a plurality of virtual objects disposed in the three-dimensional space as intended, reducing the influence of parallax.

### Embodiment 4

Embodiment 4 is an embodiment where the selection range is set in the same manner as Embodiments 1 to 3, virtual objects are changed to a selected state, and then a selection range is specified to set a part of the selected virtual objects to a deselected state. The selection unit 1120 can specify a selection range based on a predetermined operation by the user. The configuration of the image processing system 100 according to Embodiment 4 is the same as Embodiment 1. In the following, aspects different from Embodiments 1 to 3 will be mainly described.

In Embodiment 4, the selection unit 1120 specifies a depth direction of the selection range. First in the selection mode, the selection unit 1120 changes the virtual objects included in the selection range specified by the user to the selected state. Specifically, the selection unit 1120 determines a region on the XY plane included in the selection range based on the distance to the virtual object in the depth direction (Z axis direction), and determines whether or not the virtual object is included in the selection range. In the case where the virtual object is included in the selection range, the selection unit 1120 changes this virtual object to the selected state. The selection mode ends if the virtual object is selected.

When the selection mode ends and a selection range specification mode starts to specify the depth direction of the selection range, the selection unit 1120 receives from the user a predetermined operation to specify the depth direction of the selection range. In accordance with the predetermined operation by the user, the selection unit 1120 sets a part of the selected virtual objects to the deselected state.

The predetermined operation to specify the depth direction of the selection range is, for example, extending the index finger of the left hand in the depth direction, touching the tip of the index finger of the right hand to the index finger of the left hand, and moving these fingers to the rear side or the front side in this state. In the case of moving the tip of the index finger of the right hand to the rear side, the selection unit 1120 changes the selected virtual objects to the deselected state, one at a time from the front side. In the case of moving the tip of the index finger of the right hand to the front side, on the other side, the selection unit 1120 changes the selected virtual objects to the deselected state, one at a time from the rear side.

For example, if the user specifies the selected region 3100 in FIG. 4, the three-dimensional selection range includes the virtual object 3040 and the virtual object 3070. The selection unit 1120 sets the virtual object 3040 and the virtual object 3070 to the selected state. When the selection range specification mode starts, and the user touches the tip of the index finger of the right hand to the index finger of the left hand, and moves these fingers to the rear side in this state, the selection unit 1120 changes the virtual object 3040 to the deselected state. The selection unit 1120 may change one virtual object to the deselected state when a finger of the right hand moved by a predetermined moving distance, for example.

The predetermined operation to specify the depth direction of the selection range is not limited to the above mentioned operation. The predetermined operation may be an operation to move the position of the hand of the user in the depth direction. For example, when the user moves one hand (e.g. right hand) to the rear side in the Z axis direction after the selection range is set and the selection mode ends, the selection unit 1120 cancels the selection of the selected virtual objects one at a time from the front side. When the user moves one hand to the front side in the Z axis direction, on the other hand, the selection unit 1120 cancels selection of the selected virtual objects one at a time from the rear side.

The predetermined operation to specify the depth direction of the selection range may also be an operation to move the thumb of one hand to the rear side or the front side in the Z axis direction. Further, the selection unit 1120 may limit the selection range in the depth direction, in accordance with the positional relationship between the fingertip of the thumb and the fingertip of the index finger of one hand. For example, the predetermined operation is an operation of the user turning the fingertip of the index finger to the front side and touching the fingertip of the thumb to the index finger, and moving the fingers in this state. The selection unit 1120 may limit the selection range to the rear side when the user approaches the thumb toward the root of the index finger.

The predetermined operation to specify the depth direction of the selection range may be Pinch-In or Pinch-Out operations using the hand. For example, after the selection range is set and the selection mode ended, the user can limit or expand the selection range in the depth direction by an operation of moving the thumb and the index finger of one hand close to each other or away from each other.

When the Pinch-In operation of moving the thumb and the index finger close to each other is detected, the selection unit 1120 narrows the selection range from both the front side and the rear side. The selection unit 1120 cancels the selection of a virtual object disposed on the front side or the rear side, and leaves a virtual object disposed in the mid-range in the selected state unchanged.

Further, in the case where the Pinch-Out operation to move the thumb and the index finger apart from each other is detected, the selection unit 1120 may expand the selection range and bring the selection-cancelled virtual object back to the selected state. Furthermore, in the case where the selection range in the depth direction is specified by the Pinch-In operation or the Pinch-Out operation, and the entire hand is moved in the Z axis direction thereafter without changing the distance between the thumb and the index finger, the selection unit 1120 may shift the selection range in the Z axis direction in accordance with the movement of the hand. Instead of the case of moving the entire hand in the Z axis direction, the selection unit 1120 may shift the selection range in the Z axis direction in the case where the entire hand of the user moved in the vertical direction (Y axis direction) or in the direction of Pinch-In or Pinch-Out.

In Embodiment 4 described above, the information processing apparatus 1100 limits the selection range in the depth direction based on the user operation. Therefore even if a plurality of virtual objects disposed in the virtual space overlap in the depth direction, the user can smoothly select a desired virtual object as intended. Furthermore, instead of limiting the selection range in the depth direction using both hands, the user can limit the selection range in the depth direction by an operation using one hand, whereby a desired virtual object can be easily selected.

### Embodiment 5

In each embodiment described above, each component of the information processing apparatus 1100 indicated in FIG. 1 is configured by hardware. In Embodiment 5, a part of the components of the information processing apparatus 1100 is configured by software. The information processing apparatus 1100 according to Embodiment 5 is a computer, where a part of the operations (functions) described in each of the above embodiments is implemented by software, and the rest of the operations is implemented by hardware.

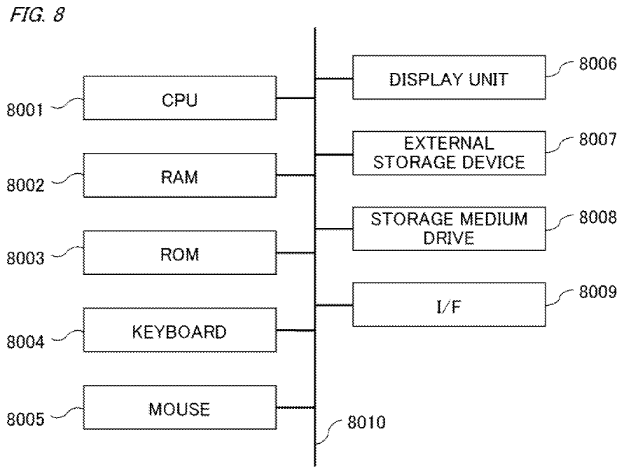

FIG. 8 is a block diagram depicting an example of the hardware configuration of a computer that is applicable to the information processing apparatus 1100. A CPU 8001 controls the computer in general using programs and data stored in a RAM 8002 and a ROM 8003, and executes each processing of the information processing apparatus 1100 described in each embodiment.

The RAM 8002 has a region to temporarily store programs and data loaded from an external storage device 8007 or a storage medium drive 8008. The RAM 8002 has an area to temporarily store data received from an external device via an interface (I/F) 8009. The external device is the display device 1000, for example. The data received from the external device is input values which the input device of the display device 1000 generated based on the real space image and operation from the user, for example.

The RAM 8002 also includes a work area that is used for the CPU 8001 to execute each processing. In other words, the RAM 8002 can provide various areas as needed. For example, the RAM 8002 also functions as the data storage unit 1150 indicated in FIG. 1.

The ROM 8003 is a non-volatile memory that stores the setting data of the computer, the boot program, and the like.

A keyboard 8004 and a mouse 8005 are examples of an operation input device, by which the user of the computer can input various instructions to the CPU 8001.

The display unit 8006 is a CRT display or a liquid crystal display, for example, and can display the processing result of the CPU 8001 using images, text and the like. For example, the display unit 8006 can display messages to measure the position and posture of the display device 1000.

The external storage device 8007 is a large capacity information storage device, such as a hard disk drive. The external storage device 8007 stores an operating system (OS), and programs and data for the CPU 8001 to execute each processing of the information processing apparatus 1100.

The programs stored in the external storage device 8007 include programs corresponding to each processing of the position and posture acquisition unit 1110, the selection unit 1120, the image generation unit 1130 and the image combining unit 1140 respectively. The data stored by the external storage device 8007 includes not only data on the virtual space, but also information described as “known information”, and various setting information. The programs and data stored in the external storage device 8007 are loaded to the RAM 8002 when necessary, based on control by the CPU 8001. The CPU 8001 executes processing using the programs and data loaded to the RAM 8002, so as to execute each processing of the information processing apparatus 1100. The data storage unit 1150 indicated in FIG. 1 may be used as the external storage device 8007.

The storage medium drive 8008 reads programs and data recorded in a computer-readable storage medium (e.g. CD-ROM, DVD-ROM), or writes programs and data to the storage media. A part or all of the programs and data stored in the external storage device 8007 may be recorded in such a storage medium. The programs and data which the storage medium drive 8008 read from the storage medium are outputted to the external storage device 8007 or the RAM 8002.

An OF 8009 is an analog video port to connect the imaging unit 1010 of the display device 1000 or a digital input/output port (e.g. IEEE 1394). The OF 8009 may be an Ethernet® port to output a composite image to the display unit 1020 of the display device 1000. The data received via the OF 8009 is inputted to the RAM 8002 or the external storage device 8007. In a case where the position and posture acquisition unit 1110 acquires the position-and-posture information using a sensor system, the OF 8009 is used as an interface to connect the sensor system. A bus 8010 interconnects each component indicated in FIG. 8.

According to the present invention, the user can easily select a desired virtual object from a plurality of virtual objects disposed in the three-dimensional space.

### OTHER EMBODIMENTS

The present disclosure includes a case of implementing the functions of each of the above embodiments by supplying software programs directly or remotely to a system or an apparatus, and a computer of the system or the apparatus reading and executing the supplied program codes. The programs supplied to the system or the apparatus are programs to execute the processing corresponding to the flow chart described in FIG. 2.

The functions of each of the above embodiments are implemented by the computer executing the program that it reads, but may also be implemented in tandem with an OS or the like running on the computer based on the instructions of the programs. In this case, the functions of each embodiment are implemented by the OS or the like executing a part or all of the functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2022-168535, filed on Oct. 20, 2022, which is hereby incorporated by reference herein in its entirety.

What is claimed is:

1. An information processing apparatus comprising at least one memory and at least one processor which function as:
a display control unit configured to perform display control of a virtual object so that the virtual object is disposed in a three-dimensional space which becomes a visual field of a user; and
a selection unit configured to set the virtual object included in a selection range in the three-dimensional space, which is selected using an operation body at a position of a hand of the user, to a selected state, wherein
the selection range is a three-dimensional range determined by expanding a two-dimensional selected region, which the user specifies using the operation body, in depth direction.

2. The information processing apparatus according to claim 1, wherein
the selection range is a three-dimensional range determined by expanding the two-dimensional selected region in the depth direction, using an origin corresponding to a position of the user and a position on a contour of the two-dimensional selected region.

3. The information processing apparatus according to claim 1, wherein
the operation body is the hand of the user, and
the two-dimensional selected region is a region enclosed by traces of a position of a hand or a position of a fingertip of the user.

4. The information processing apparatus according to claim 1, wherein
the operation body is the hand of the user, and
the two-dimensional selected region is a region specified based on position information on a plurality of points specified by the hand of the user.

5. The information processing apparatus according to claim 1, wherein
the operation body is the hand of the user, and
the two-dimensional selected region is a region enclosed by a predetermined shape of the hand of the user.

6. The information processing apparatus according to claim 5, wherein
the predetermined shape of a hand is a shape formed by approaching two fingertips of one hand toward two fingertips of another hand respectively, or a shape formed by approaching two fingertips of one hand to each other.

7. The information processing apparatus according to claim 1, wherein
the selection range is set using an origin corresponding to a position of the user, and a range from the origin in a direction toward which the operation body faces.

8. The information processing apparatus according to claim 2, wherein
the origin corresponding to the position of the user is a position of either a left or a right eye of the user.

9. The information processing apparatus according to claim 8, wherein the at least one memory and the at least one processor further function as a setting unit configured to set a dominant eye of the user, wherein
the origin corresponding to the position of the user is a position of the dominant eye of the user which is set by the setting unit.

10. The information processing apparatus according to claim 2, wherein
the origin corresponding to the position of the user is a mid-point between a left eye and a right eye of the user.

11. The information processing apparatus according to claim 1, further comprising a camera that captures a first image for a right eye and a second image for a left eye, wherein
the display control unit
displays the first image or the second image on a first display for the right eye and a second display for the left eye in a case where operation by the operation body to set the selection range is started, and
returns display of the first display and the second display back to display of the first image and display of the second image respectively in a case where the virtual object is selected by the selection unit.

12. The information processing apparatus according to claim 1, wherein
the selection range is set based on traces of a ray, which is a laser beam-like object, emitted from the operation body.

13. The information processing apparatus according to claim 12, wherein
the selection unit determines a range on a two-dimensional plane in accordance with depth distance from an emission position of the ray to the virtual object, based on an emission angle of the ray with respect to the depth direction, and determine whether or not the virtual object is included in the selection range.

14. The information processing apparatus according to claim 1, wherein
the selection unit specifies a range of the selection range in the depth direction, based on a predetermined operation by the user.

15. The information processing apparatus according to claim 14, wherein
the predetermined operation is an operation of moving the position of the hand of the user in the depth direction, and
the selection unit
cancels the selected state sequentially from the virtual object on a rear side as the hand of the user moves toward the user, and
cancels the selected state sequentially from the virtual object on a front side as the hand of the user moves away from the user.

16. The information processing apparatus according to claim 1, wherein
the display control unit displays the virtual object in the selected state, in a mode different from a case where the virtual object is not selected.

17. The information processing apparatus according to claim 1, wherein
in a case where the selection range is changed, the selection unit sets the virtual object, which is not included in the selection range, to a deselected state.

18. The information processing apparatus according to claim 1, wherein
the operation body is the hand of the user, and
the selection unit acquires the position of the hand of the user by acquiring a position of a hand or a fingertip of the user from an image captured by a camera, or based on position-and-posture information of a controller held by the hand of the user.

19. An information processing method for causing a computer to execute:
performing display control of a virtual object so that the virtual object is disposed in a three-dimensional space which becomes a visual field of a user; and
setting the virtual object included in a selection range in the three-dimensional space, which is selected using an operation body at a position of a hand of the user, to a selected state, wherein
the selection range is a three-dimensional range determined by expanding a two-dimensional selected region, which the user specifies using the operation body, in depth direction.

20. A non-transitory computer-readable medium that stores a program for causing a computer to execute an information processing method comprising:
performing display control of a virtual object so that the virtual object is disposed in a three-dimensional space which becomes a visual field of a user; and
setting the virtual object included in a selection range in the three-dimensional space, which is selected using an operation body at a position of a hand of the user, to a selected state, wherein
the selection range is a three-dimensional range determined by expanding a two-dimensional selected region, which the user specifies using the operation body, in depth direction.
